(19) United States
(12) Patent Application Publication
(10) Pub. No.: US 2016/0086163 A1
(43) Pub. Date: Mar. 24, 2016

(54) Method and System for Processing a Fuel Transaction

(71) Applicant: MasterCard International Incorporated, Purchase, NY (US)

(72) Inventors: Ahmed Hosny, Dublin (IE); Imran Shah, Dublin (IE)

(21) Appl. No.: 14/835,680

(22) Filed: Aug. 25, 2015

(30) Foreign Application Priority Data
Aug. 26, 2014 (GB) 1415091.6

(51) Int. Cl. G06Q 20/32; G07F 15/00; G06Q 50/06; G06Q 20/20

(52) U.S. Cl. CPC G06Q 20/3278; G06Q 20/202; G06Q 20/3224; G07F 15/001; G06Q 50/06; G06Q 20/3274

(57) ABSTRACT

A user is allowed to select a fuel item remotely of a fuel dispenser using a payer application accessible on a computing device. An order is generated based on the selected fuel item; the order including an identifier associated with a payer account. The order is provided to a point of sale (POS) application associated with a merchant. The POS application generates a payment request based on the order and a record of the amount of fuel dispensed by the fuel dispenser; the payment request including an identifier associated with a recipient account. The payment request is forwarded by the POS application to a payment network, which effects a payment transaction from the payer account to the recipient account. A notification is forwarded to the payer application indicating the status of the payment transaction.

### CROSS-REFERENCE TO RELATED APPLICATIONS

This application claims foreign priority to United Kingdom Patent Application No. 1415091.6, filed 26 Aug. 2014, the complete disclosure of which is expressly incorporated herein by reference in its entirety for all purposes.

### FIELD OF THE INVENTION

The present disclosure relates to a method and system for processing a fuel transaction. More particularly, it relates to a method and system for preordering and preauthorising payment prior to the fuel being dispensed at a fuel dispensing station.

### BACKGROUND OF THE DISCLOSURE

The task of obtaining fuel for a vehicle at a filling station may be time consuming. Typically, drivers are required to initially wait in line at the filling station until a fuel dispenser becomes available. Once the fuel has been dispensed it is usually necessary to pay for the fuel at a separate pay station which may result in further delays.

Fuel dispensers with integrated card readers are known which allows payment at the fuel dispenser thereby elminating the need to pay at a separate pay station. However, it is necessary to authorise payment using a credit or debit card in advance of the fuel dispenser becoming active. To authorise the payment a user has to interface with the integrated card readers using debit cards or credit cards which have a magnetic stripe on which the relevant account number is stored. To authorise the payment the card is swiped through a magnetic stripe reader that is part of a point of sale (POS) terminal or a personal identification number (PIN) is entered on a keypad using chip and pin technology. Interfacing with the card reader to effect payment authorisation can also be time consuming.

There is therefore a need for a method and system for proccessing a fuel transaction which addresses at least some of the drawbacks of the prior art.

### SUMMARY OF THE INVENTION

In accordance with an aspect of the present invention; there is provided a computer-implemented method for processing a fuel transaction, the method comprising: allowing a user to select a fuel item for purchasing remotely of a fuel dispenser using a payer application accessible on a computing device; generating an order based on the selected fuel item; the order including an identifier associated with a payer account; providing the order to a point of sale (POS) application associated with a merchant; generating by the POS application a payment request based on the order and a record of the amount of fuel dispensed by the fuel dispenser; the payment request including an identifier associated with a recipient account; forwarding the payment request by the POS application to a payment network; effecting by the payment network a payment transaction from the payer account to the recipient account; and forwarding a notification to the payer application indicating the status of the payment transaction.

In one embodiment the fuel item is associated with a quantity of fuel. In an exemplary arrangement the fuel item is associated with a monetary value.

In a further embodiment the order is provided to the POS application using a proximity detection mechanism. In one arrangement, the proximity detection mechanism uses near field communication techniques. In another arrangement, the proximity detection mechanism uses location information associated with the user.

In an exemplary embodiment, the order includes a machine readable code. The machine readable code may comprise a bar code. The machine readable code may comprise quick response (QR) code.

In one embodiment a database is provided which is accessible by the payment network. In an exemplary configuration, the database comprises particulars associated with the payer. The database may also comprise particulars associated with the merchant.

In one embodiment, the POS application is operable to push data to the payer application. In an exemplary arrangement, a plurality of POS applications are operable to push data to the payer application.

In an exemplary configuration, the POS application is operable to request verification data from the payer application. In one arrangement, the POS application is configured to receive a verification code from the user.

In accordance with another aspect of the invention, a computer-readable medium is provided comprising non-transitory instructions which, when executed, cause a processor to carry out a method of processing a fuel transaction, the method comprising: allowing a user to select a fuel item for purchasing remotely of a fuel dispenser using a payer application accessible on a computing device; generating an order based on the selected fuel item; the order including an identifier associated with a payer account; providing the order to a point of sale (POS) application associated with a merchant; generating by the POS application a payment request based on the order and a record of the amount of fuel dispensed by the fuel dispenser; the payment request including an identifier associated with a recipient account; forwarding the payment request by the POS application to a payment network; effecting by the payment network a payment transaction from the payer account to the recipient account; and forwarding a notification to payer application indicating the status of the payment transaction.

In a further aspect of the invention there is provided a system for processing a fuel transaction; the system comprising one or more modules which are configured to allowing a user to select a fuel item for purchasing remotely of a fuel dispenser using a payer application accessible on a computing device; generating an order based on the selected fuel item; the order including an identifier associated with a payer account; providing the order to a point of sale (POS) application associated with a merchant; generating by the POS application a payment request based on the order and a record of the amount of fuel dispensed by the fuel dispenser; the payment request including an identifier associated with the merchant's account; forwarding the payment request by the POS application to a payment network; effecting by the payment network a payment transaction from the payer account to the merchant's account; and forwarding a notification to payer application indicating the status of the payment transaction

### BRIEF DESCRIPTION OF THE DRAWINGS

Embodiments of the present invention will now be described, by way of example only, with reference to the accompanying drawings, in which:

FIG. 1 is a diagram of a system which is configured for funding a fuel transaction in accordance with the present teaching;

FIG. 2 is a flow diagram depicting an exemplary method of processing a fuel transaction in accordance with the present teaching; and

FIG. 3 is a diagram of another system which is configured for funding a fuel transaction which is also in accordance with the present teaching.

### DESCRIPTION OF THE PREFERRED EMBODIMENT

Embodiments of the present invention will now be described with reference to an exemplary system for processing a fuel transaction. It will be understood that the exemplary system is provided to assist in an understanding of the present teaching and is not to be construed as limiting in any fashion. Furthermore, modules or elements that are described with reference to any one Figure may be interchanged with those of other Figures or other equivalent elements without departing from the spirit of the present teaching.

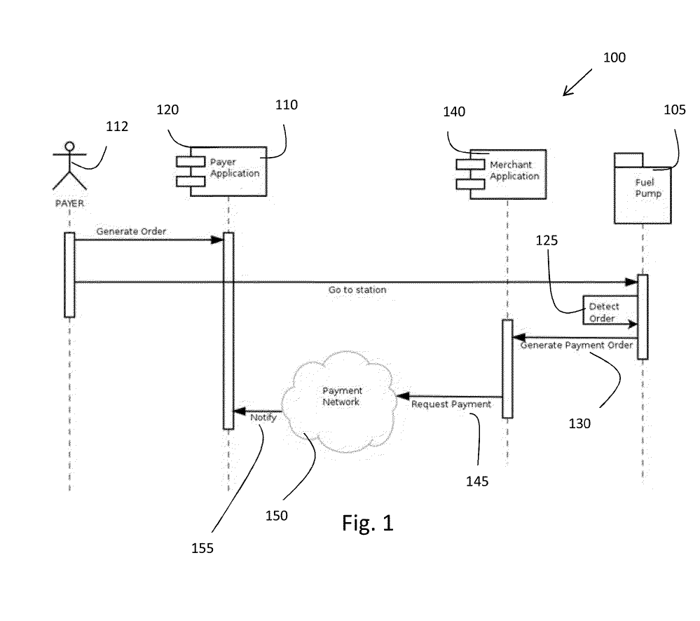

Referring to the drawings and, in particular to FIG. 1, an exemplary system 100 for processing a fuel transaction is illustrated. The system 100 facilitates remote ordering of fuel using an on-line platform in advance of a user arriving at a fuel dispenser 105. The system 100 allows a user to arrange payment for fuel prior to the fuel being dispensed. It will be appreciated that in the following, the term account is intended to include bank accounts, credit accounts, deposit accounts, checking accounts and the like.

The system 100 comprises a payer application 110 which is accessible via a computing device 120. The computing device 120 may be a smart phone, computing tablet, or any other suitable computing device. The payer application 110 has an 15 graphical user interface which allows a user 112 to select a fuel item for purchasing. The fuel item may a quantity of a type of fuel or a monetary value. The payer application 110 may be activated on the computing device 120 in advance of the user arriving at a fuel station so that the user 112 can order fuel and authorise payment at their convenience. An order is generated by the payer application 120 in response to a user selecting a fuel item for purchase. The order includes an identifier associated with a payer account from which payment is authorised. The order is detected upon the user 112 driving to the fuel dispenser 105. A proximity detection mechanism 125 may be used to detect the order on the payer application 110 which is displayed on the computing device 120. The proximity detection mechanism 125 may be configured to use near field communication (NFC) or a quick release (QR) code. The user activates the fuel dispenser 105 in order to dispense a volume of fuel into a vehicle. The fuel dispenser 105 is configured to generate a record of the fuel which is dispensed. The fuel dispenser 105 generates a payment order 130 which includes details of the detected order from the payer application 110 and a record of the amount of fuel dispensed from the fuel dispenser 105. A point of sale (POS) application 140 which is associated with a mechant receives the payment order from the fuel dispenser 105. The POS application 140 then generates a payment request 145 which includes the identifier of the payer account, an identifier associated with a recipient account, and the value of the fuel which was dispensed at the fuel dispenser 105. The POS application 140 then forwards the payment request 145 to a payment network 150 which is operable to effect a payment transaction such that a value corresponding to the monetary value of the dispensed fuel is transferred from the payer account to the recipient account. Upon completing the payment transaction the payment network 150 generates a notification 155 which details the status of the payment transaction. The notification 115 is then forwarded from the payment network 150 to the payer application 110 for displaying on the computing device 120.

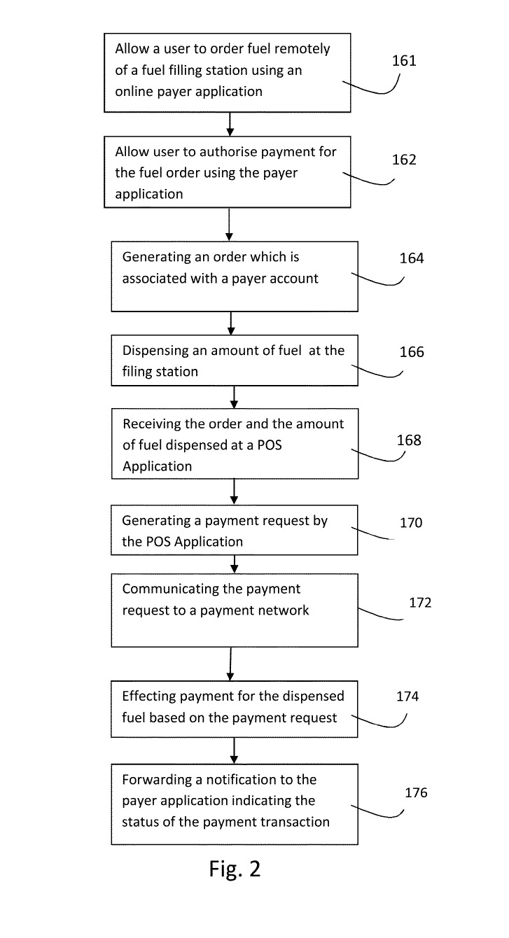

FIG. 2 depicts exemplary steps performed by the system 100 when processing a fuel transaction. At block 161, the pay application 110 is configured on the computing device 120 to allow a user to order fuel remotely of a fuel filling station by selecting a fuel item for purchasing. At block 162, the pay application 110 facilitates the user to authorize payment for the fuel order using the payer application. At block 164, the payer application 110 generates an order based on the fuel item selected by the user 112 and includes details of an account that the individual 112 has pre-authorized the fuel payment to be deducted from. At block 166, the individual 112 arrives at the fuel dispenser 105 and the order is detected on the payer application 110 is detected. The individual's vehicle receives a volume of fuel from the fuel dispenser 105. At block 168, the POS application receives the order and a record of the amount of fuel dispensed to fill the order. At block 170, the POS application 140 generates a payment request which includes the identifier of the payer account, an identifier associated with a recipient account, and the monetary value of the fuel which was dispensed at the fuel dispenser 105. At block 172, the payment request is forwarded to a payment network 150. At block 174, the payment network 150 effects a payment transaction such that a value corresponding to the monetary value of the dispensed fuel is transferred from the payer account to the recipient account. At block 176, upon completing the payment transaction the payment network 150 generates a notification 155 which details the status of the payment transaction which is then forwarded to the payer application 110 for displaying on the computing device 120.

It will be appreciated that the system 100 includes one or more software modules which are programmed to implement predefined functions. For example, a first software module may be provided for allowing a user to select a fuel item on the payer application 110. A second software module may be configured to generate an order based on the selected fuel item such that the order includes an identifier associated with a payer account. A third software module may be provided for providing the order to a point of sale (POS) application associated with a merchant. A fourth software module may be configured for instructing the POS application to generate a payment request based on the order and a record of the amount of fuel dispensed by the fuel dispenser. A fifth software module may be provided for forwarding the payment request by the POS application to a payment network. A sixth software module may be configured for effecting by the payment network a payment transaction from the payer account to the recipient account. A seventh software module may be provided for forwarding a notification to payer application indicating the status of the payment transaction. While seven software modules have been described for controlling the operations of the system 100, it is not intended to limit to present teaching to a specific number of software modules. It will be appreciated by those skilled in the art that any desired number of software modules may be programmed to implement the functionality of the system 100.

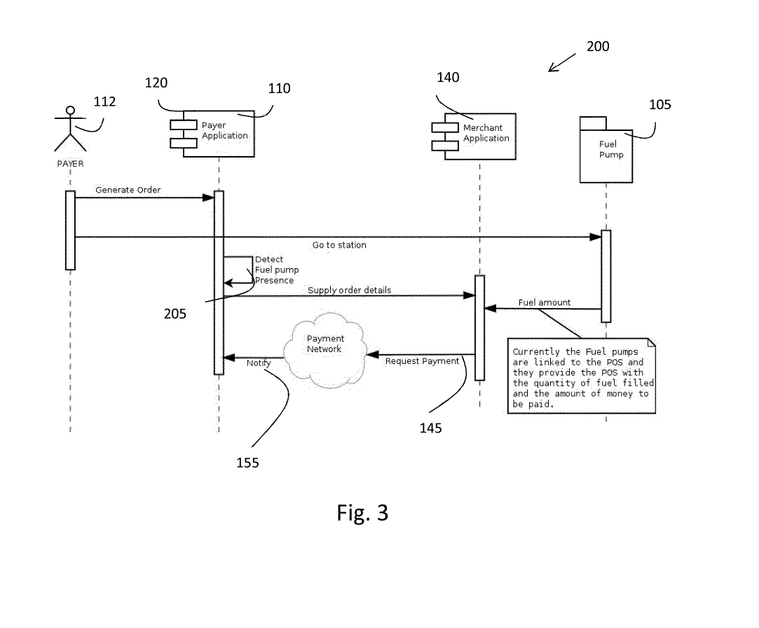

Referring to FIG. 3 there is illustrated another system 200 for processing a fuel transaction which is also in accordance with the present teaching. The system 200 is substantially similar to the system 100 and like components are indicated by similar reference numerals. The main difference is that the system 200 does not include a proximity detection mechanism 125. Instead the system 200 includes a geo-positional module 205 on the payer application 120 for detecting when the computing device 120 arrives at the fuel dispenser 105. The geographical coordinates of the fuel dispenser 105 are provided to the pay application 120 when the merchant registers with the system 100. The geo-positional module 205 is configured to track the geographical coordinates of the communication device 120 and it is therefore able to determine by cross referencing these tracked coordinates against the stored coordinates of the fuel dispenser when the individual 112 arrives at the fuel dispenser 105. Once the presence of the individual 112 is detected at the fuel dispenser 105, the order is forwarded from the pay application 110 to the POS application 140. The fuel dispenser 105 is linked to the POS application 140 and is configured to provide the POS application 140 with a record of the volume of fuel dispensed. The POS Application 140 is operable to generate the payment request 145 in a similar fashion as described with reference to the system 100 and the payment transaction is processed in a similar manner.

The payer application 120 may be either a mobile or a web application. The payer application 120 may be used to specify either the quantity of fuel to be purchased or the amount of money to be paid for the fuel. Depending on the application, a code will be generated and associated with the payer. The payer can assign the order to a different person for their use if desired. The merchant application 140 detects the order either through any of the methods described in the previous step and converts it to a payment request 145 adding the merchant details to the operation.

A central database is connected to the payment network to process the payment requests. The central database contains the payer's details (credit card number, username, password, etc.), the merchant's details (location, special offers, price, opening times, etc) and the payments details as well. It receives the payment request 145 and converts it to a card payment and requests the payment on behalf of the merchant over the card payment network.

It will be understood that what has been described herein is an exemplary system 100 for processing a fuel transaction. While the present disclosure has been described with reference to exemplary arrangements it will be understood that it is not intended to limit the disclosure to such arrangements as modifications can be made without departing from the spirit and scope of the present teaching. The method of the present teaching may be implemented in software, firmware, hardware, or a combination thereof. In one mode, the method is implemented in software, as an executable program, and is executed by one or more special or general purpose digital computer(s). The steps of the method may be implemented by a server or computer in which the software modules reside or partially reside.

Generally, in terms of hardware architecture, such a computer will include, as will be well understood by the person skilled in the art, a processor, memory, and one or more input and/or output (I/O) devices (or peripherals) that are communicatively coupled via a local interface. The local interface can be, for example, but not limited to, one or more buses or other wired or wireless connections, as is known in the art. The local interface may have additional elements, such as controllers, buffers (caches), drivers, repeaters, and receivers, to enable communications. Further, the local interface may include address, control, and/or data connections to enable appropriate communications among the other computer components.

The processor(s) may be programmed to perform the functions of the first, second, third, fourth, fifth, sixth and seventh software modules as described above. The processor(s) is a hardware device for executing software, particularly software stored in memory. Processor(s) can be any custom made or commercially available processor, a central processing unit (CPU), an auxiliary processor among several processors associated with a computer, a semiconductor based microprocessor (in the form of a microchip or chip set), a macroprocessor, or generally any device for executing software instructions.

Memory is associated with processor(s) and can include any one or a combination of volatile memory elements (e.g., random access memory (RAM, such as DRAM, SRAM, SDRAM, etc.)) and nonvolatile memory elements (e.g., ROM, hard drive, tape, CDROM, etc.). Moreover, memory may incorporate electronic, magnetic, optical, and/or other types of storage media. Memory can have a distributed architecture where various components are situated remote from one another, but are still accessed by processor(s).

The software in memory may include one or more separate programs. The separate programs comprise ordered listings of executable instructions for implementing logical functions in order to implement the functions of the modules. In the example of heretofore described, the software in memory includes the one or more components of the method and is executable on a suitable operating system (O/S).

The present disclosure may include components provided as a source program, executable program (object code), script, or any other entity comprising a set of instructions to be performed. When a source program, the program needs to be translated via a compiler, assembler, interpreter, or the like, which may or may not be included within the memory, so as to operate properly in connection with the O/S. Furthermore, a methodology implemented according to the teaching may be expressed as (a) an object oriented programming language, which has classes of data and methods, or (b) a procedural programming language, which has routines, subroutines, and/or functions, for example but not limited to, C, C++, Pascal, Basic, Fortran, Cobol, Perl, Java, and Ada.

When the method is implemented in software, it should be noted that such software can be stored on any computer readable medium for use by or in connection with any computer related system or method. In the context of this teaching, a computer readable medium is an electronic, magnetic, optical, or other physical device or means that can contain or store a computer program for use by or in connection with a computer related system or method. Such an arrangement can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be for example, but not limited to, an electronic, magnetic, optical, electromagnetic, infrared, or semiconductor system, apparatus, device, or propagation medium. Any process descriptions or blocks in the Figures, should be understood as representing modules, segments, or portions of code which include one or more executable instructions for implementing specific logical functions or steps in the process, as would be understood by those having ordinary skill in the art.

It will be appreciated that the system 100 may be implemented using cloud or local server architecture. In this way it will be understood that the present teaching is to be limited only insofar as is deemed necessary in the light of the appended claims.

It is envisaged that the payer application 110 is operable to support different types of promotions. These promotions can be related to: time of day promotions (the fuel station may wish to provide a promotion for when the traffic is low—at work time for example—to increase its utilization), shop related promotions (where the fuel station will provide a promotion that is claimable at the shop attached with the station for its customers) or loyalty promotions (related to the quantity of fuel or to the usage patterns and so on).

Also the payer application 110 is operable to provide both the customer and the fuel station with different types of reporting. Reporting for customer may include the quantity of fuel used/amount of money spent on fuel per different time units (daily, weekly, monthly, etc). These quantities/amounts may be related to targets and averages and the customer is able to monitor the usage patterns. Reporting for fuel station may include the quantity of fuel served/amount of money gained through the use of the application per different time units (daily, weekly, monthly, etc). These quantities/amounts may be related to targets and averages and the fuel station is able to monitor its benefits from supporting the payer application 120.

The orders may have at least two formats. The first format is limited to a high end order where the customer sets the maximum amount of money/maximum quantity of fuel desired. The second format includes an unlimited quantity/amount in respect of a single fuelling.

It should be emphasized that the above-described embodiments of the present teaching, particularly, any “preferred” embodiments, are possible examples of implementations, merely set forth for a clear understanding of the principles. Many variations and modifications may be made to the above-described embodiment(s) without substantially departing from the spirit and principles of the present teaching. All such modifications are intended to be included herein within the scope of this disclosure and the present invention and protected by the following claims. For example, steps associated with the processes described herein can be performed in any order, unless otherwise specified or dictated by the steps themselves. The present disclosure is intended to embrace all such alternatives, modifications and variances that fall within the scope of the appended claims.

Similarly the words comprises/comprising when used in the specification are used to specify the presence of stated features, integers, steps or components but do not preclude the presence or addition of one or more additional features, integers, steps, components or groups thereof.

What is claimed is:

1. A computer-implemented method of processing a fuel transaction, the method comprising:
allowing a user to select a fuel item for purchasing remotely of a fuel dispenser using a payer application accessible on a computing device;
generating an order based on the selected fuel item; the order including an identifier associated with a payer account;
providing the order to a point of sale (POS) application associated with a merchant;
generating by the POS application a payment request based on the order and a record of the amount of fuel dispensed by the fuel dispenser; the payment request including an identifier associated with a recipient account;
forwarding the payment request by the POS application to a payment network;
effecting by the payment network a payment transaction from the payer account to the recipient account; and
forwarding a notification to the payer application indicating the status of the payment transaction.

2. The method of claim 1, wherein the fuel item is associated with a quantity of fuel.

3. The method of claim 1, wherein the fuel item is associated with a. monetary value.

4. The method of claim 1, wherein the order is provided to the POS application using a proximity detection mechanism.

5. The method of claim 4, wherein the proximity detection mechanism uses near field communication techniques.

6. The method of claim 4, wherein the proximity detection mechanism uses location information associated with the user.

7. The method as claimed in claim 1, wherein the order includes a machine readable code.

8. The method as claimed in claim 7, wherein the machine readable code comprises a bar code.

9. The method as claimed in claim 7, wherein the machine readable code comprises quick response (QR) code.

10. The method as claimed in claim 1, further comprising providing a database.

11. The method as claimed in claim 10, wherein the database is accessible by the payment network.

12. The method as claimed in claim 10, wherein the database comprises particulars associated with the payer.

13. The method as claimed in claim 10, wherein the database comprises particulars associated with the merchant.

14. The method as claimed in claim 1, wherein the POS application is operable to push data to the payer application.

15. The method as claimed in claim 14, wherein a plurality of POS applications are operable to push data to the payer application.

16. The method as claimed in claim 14; wherein the POS application is operable to request verification data from the payer application.

17. The method as claimed in claim 16, wherein the POS application is configured to receive a verification code from the user.

18. A non-transitory computer readable medium comprising computer executable instructions which when executed by a computer cause the computer to perform a method of processing a fuel transaction, the method comprising:
allowing a user to select a fuel item for purchasing remotely of a fuel dispenser using a payer application accessible on a computing device;
generating an order based on the selected fuel item; the order including an identifier associated with a payer account;
providing the order to a point of sale (POS) application associated with a merchant;
generating by the POS application a payment request based on the order and a record of the amount of fuel dispensed by the fuel dispenser; the payment request including an identifier associated with a recipient account;
forwarding the payment request by the POS application to a payment network;
effecting by the payment network a payment transaction from the payer account to the recipient account; and
forwarding a notification to the payer application indicating the status of the payment transaction.

19. A system for processing a fuel transaction; the system comprising one or more modules which are configured to:
allow a user to select a fuel item for purchasing remotely of a fuel dispenser using a payer application accessible on a computing device;
generate an order based on the selected fuel item; the order including an identifier associated with a payer account;
provide the order to a point of sale (POS) application associated with a merchant;
generate by the POS application a payment request based on the order and a record of the amount of fuel dispensed by the fuel dispenser; the payment request including an identifier associated with the merchant's account;
forward the payment request by the POS application to a payment network;
effect by the payment network a payment transaction from the payer account to the merchant's account; and
forward a notification to the payer application indicating the status of the payment transaction

20. A point of sale device, associated with a merchant, comprising:
a memory; and
at least one processor, coupled to the memory, and operative to:
obtain an order generated based on a fuel item selected by a user for purchasing remotely of a fuel dispenser using a payer application accessible on a computing device, the order including an identifier associated with a payer account;
generate a payment request based on the order and a record of the amount of fuel dispensed by the fuel dispenser; the payment request including an identifier associated with a recipient account; and
forwarding the payment request by the POS application to a payment network so that the payment network can effect a payment transaction from the payer account to the recipient account and so that a notification can be forwarded to the payer application indicating the status of the payment transaction.

21. A mobile phone, comprising:
a memory; and
at least one processor, coupled to the memory, and operative to:
allow a user to select a fuel item for purchasing remotely of a fuel dispenser using a payer application accessible on the mobile phone;
generate an order based on the selected fuel item; the order including an identifier associated with a payer account;
provide the order to a point of sale (POS) application associated with a merchant so that the POS application can generate a payment request based on the order and a record of the amount of fuel dispensed by the fuel dispenser; the payment request including an identifier associated with a recipient account and so that the POS application can forward the payment request to a payment network which effects a payment transaction from the payer account to the recipient account; and
obtain a notification indicating the status of the payment transaction.

22. A payment network configured to:
obtain from a POS application a payment request based on an order based on a fuel item detected by a user for purchasing remotely of a fuel dispenser using a payer application accessible on a computing device, the order including an identifier associated with a payer account, the payment request including an identifier associated with a recipient account;
effect a payment transaction from the payer account to the recipient account; and
forward a notification to the payer application indicating the status of the payment transaction.
